(19) United States
(12) Patent Application Publication
(10) Pub. No.: US 2014/0085797 A1
(43) Pub. Date: Mar. 27, 2014

(54) ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-KANG CHO, New Taipei (TW); QUAN LIAO, Shenzhen (CN); FENG-LIN LIU, New Taipei (TW); JIE-FENG HE, Shenzhen (CN); LEI-BO ZHANG, Shenzhen (CN); DAN HUANG, Shenzhen (CN)

(21) Appl. No.: 13/915,790

(22) Filed: Jun. 12, 2013

(30) Foreign Application Priority Data
Sep. 25, 2012 (CN) 2012103600713

(51) Int. Cl. G06F 1/16

(52) U.S. Cl. CPC G06F 1/1601
USPC 361/679.21

(57) ABSTRACT

An electronic device includes a display, a base, a stand, and a cable. The display has a space for a motherboard. The base includes a base body. A data storage device is located in the base body. The stand connects the display to the base. The cable connects the motherboard to the data storage device and extends through the stand.

### BACKGROUND

1. Technical Field

The present disclosure relates to electronic devices, more particularly to an all-in-one.

2. Description of Related Art

An electronic device such as an all-in-one usually consists of a host and an integral display. Usually, there is a space in the back of the display where there is a motherboard with a plurality of electronic components, such as a CPU, a fan, and a plurality of data storage devices crowded together in the space. However, the plurality of data storage devices is such that the space is crowded, so it is inconvenient to maintain. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an exploded, isometric view of an electronic device in accordance with an embodiment.

FIG. 2 is similar to FIG. 1, but viewed from a different angle.

FIG. 3 is an assembled view of the electronic device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

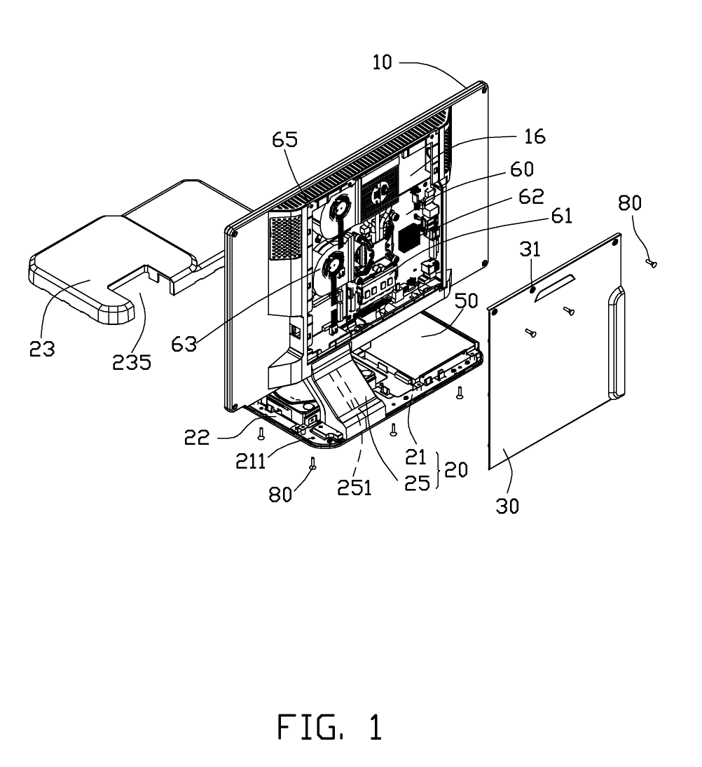

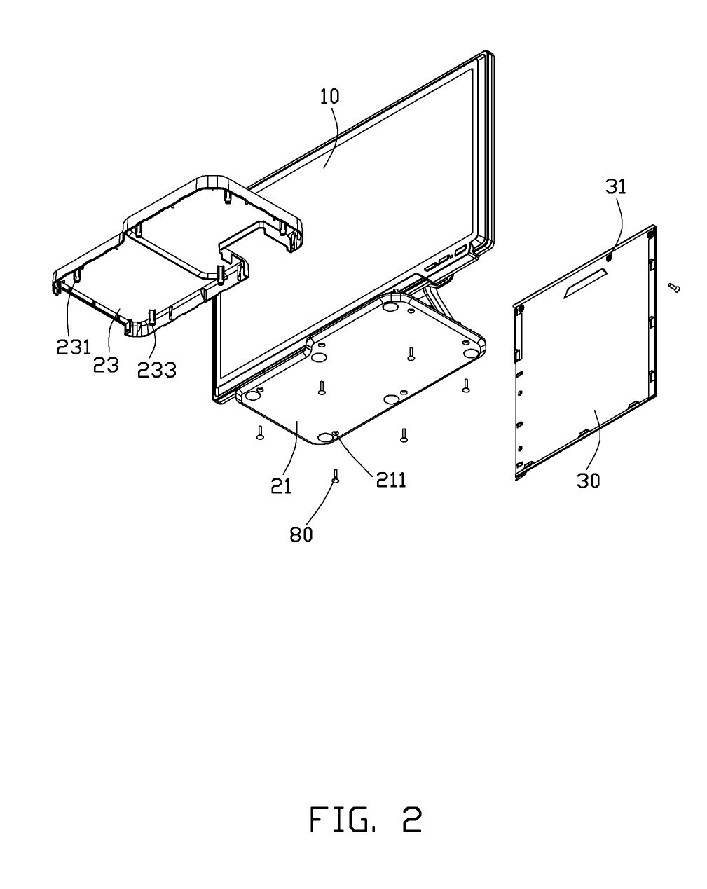

FIGS. 1-2 illustrate an electronic device in accordance with an embodiment. The electronic device comprises a display 10 and a base 20 connected to the display 10. In one embodiment, the electronic device is an all-in-one.

The base 20 comprises a base body 21 and a stand 25 slantedly connected to the display 10 and the base body 21. The base body 21 comprises a bottom plate 22 and a cover 23. The stand 25 defines a cable-receiving hole 251. A plurality of data storage devices 50 is secured to the bottom plate 22. A plurality of first-securing holes 211 is defined in the bottom plate 22 and around the data storage devices 50. A plurality of securing posts 231 protrudes from an inner surface of the cover 23, and a second-securing hole 233 is defined in each of the securing posts 231. A length of each securing post 231 is greater than a height of each data storage device 50. A cutout 235 is defined in the cover 23 to accommodate one end of the stand 25.

A receiving space 16 is defined in a rear portion of the display 10. A motherboard 60 is received in the receiving space 16. A plurality of electronic components, such as a plurality of expansion cards 61, a heat dissipating device 62, and a fan 63 is secured to the motherboard 60. A plurality of first-mounting holes 65 is defined in the display 10 and around the receiving space 16.

A rear plate 30 can be secured to the rear portion of the display 10 for covering the receiving space 16. A plurality of second-mounting holes 31 is defined in the rear plate 30 and aligned with the plurality of first-mounting holes 65.

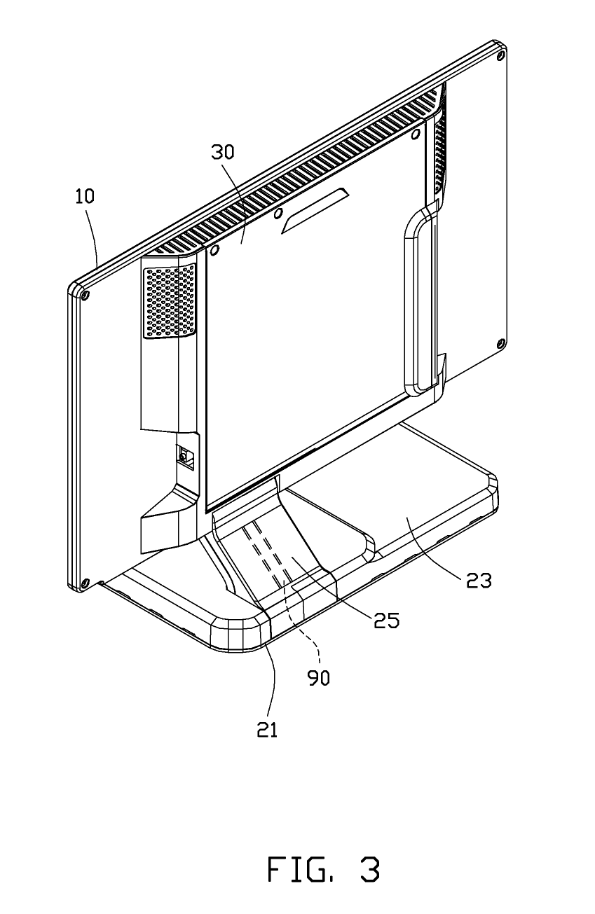

FIGS. 1-3 show in assembly, the stand 25 secured in the cutout 235. The securing posts 231 are on the bottom plate 22 for support. The second-securing holes 233 are aligned with the first-securing holes 211. A plurality of mounting members 80 is engaged in the second-securing holes 233 and the first-securing holes 211. Thus, the data storage devices 50 are secured to the base body 21 and located between the bottom plate 22 and the cover 23.

The second-mounting holes 31 are aligned with the first-mounting holes 65. The mounting members 80 are engaged in the second-mounting holes 31 and the first-mounting holes 65, and the rear plate 30 is secured to the display 10. The motherboard 60 and the electronic components on the motherboard 60 are together covered by the rear plate 30. A cable 90 extends through the cable-receiving hole 251 to electronically connect the motherboard 60 to the data storage devices 50.

The data storage devices 50 are secured to the base body 21 so that the receiving space 16 is not crowded. The data storage devices 50 are separated from the electronic components of the motherboard 60, so that when the data storage devices 50 are running, vibrations from the data storage devices 50 won't influence the electronic devices of the motherboard 60.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a display; a receiving space defined in the display, and a motherboard received in the receiving space;
a base supporting the display and comprising a base body and a stand located on the base body and supporting the display, a data storage device located in the base body;
a cable connecting the motherboard to the data storage device extending through the stand.

2. The electronic device of claim 1, wherein the base body comprises a bottom plate connected to the stand, and the stand is slanted relative to the bottom plate.

3. The electronic device of claim 2, wherein the base body further comprises a cover attached to the bottom plate, and the data storage device is located between the cover and the bottom plate.

4. The electronic device of claim 3, wherein the cover defines a cutout, and the stand extends through the cutout.

5. The electronic device of claim 4, wherein a securing post extends from an inner surface of the cover and supports on the bottom plate, and a length of the securing post is greater than a width of the data storage device.

6. The electronic device of claim 5, wherein the bottom plate defines a first securing hole, the securing post defines a second securing hole, and a mounting member is engaged in the first securing hole and the second securing hole to secure the cover to the bottom plate.

7. The electronic device of claim 1, wherein the stand defines a cable receiving hole, and the cable is extends through the cable receiving hole.

8. The electronic device of claim 1, further comprising a rear plate; wherein the rear plate is secured to the display, and the receiving space is covered by the rear plate.

9. An electronic device comprising:
a display; a receiving space defined in the display, and a motherboard received in the receiving space;
a base supporting the display and comprising a base body, a data storage device located in the base; and
a cable and connecting the data storage device to the motherboard.

10. The electronic device of claim 9, further comprising a stand located on the base body and supporting the display, wherein a cable receiving hole is defined in the stand, and the cable extends through the cable receiving hole to connect the data storage device to the motherboard.

11. The electronic device of claim 10, wherein the base body comprises a bottom plate connected to the stand, and the stand is slanted relative to the bottom plate.

12. The electronic device of claim 11, wherein the base body further comprises a cover attached to the bottom plate, and the data storage device is located between the cover and the bottom plate.

13. The electronic device of claim 12, wherein the cover defines a cutout, and the stand extends through the cutout.

14. The electronic device of claim 13, wherein a securing post extends from an inner surface of the cover and supports on the bottom plate, and a length of the securing post is greater than a width of the data storage device.

15. The electronic device of claim 14, wherein the bottom plate defines a first securing hole, the securing post defines a second securing hole, a mounting member is engaged in the first securing hole and the second securing hole, to secure the cover to the bottom plate.

16. The electronic device of claim 9, further comprising a rear plate; wherein the rear plate is secured to the display, and the receiving space is covered by the rear plate.
